(19) United States
(12) Patent Application Publication
(10) Pub. No.: US 2025/0229257 A1
(43) Pub. Date: Jul. 17, 2025

(54) PREPARATION METHOD AND APPLICATION METHOD OF NI-CO BIMETALLIC CATALYST FOR DRY REFORMING OF METHANE

(71) Applicant: East China University of Science and Technology, Shanghai (CN)

(72) Inventors: Chengcheng Tian, Shanghai (CN); Xiaoxiao Zhu, Yongcheng (CN); Zhengcheng Wang, Hangzhou (CN); Cong Yuan, Yancheng (CN); Shanshan Zhang, Qingdao (CN); Qiying Zheng, Tianjin (CN); Xiang Zhu, Shanghai (CN)

(21) Appl. No.: 18/963,778

(22) Filed: Nov. 29, 2024

(30) Foreign Application Priority Data
Jan. 11, 2024 (CN) 202410043179.2

(51) Int. Cl. B01J 23/755; B01J 37/00; B01J 37/04; B01J 37/08; B01J 37/34; C01B 3/40

(52) U.S. Cl. CPC B01J 23/755; B01J 37/0036; B01J 37/04; B01J 37/088; B01J 37/343; C01B 3/40; C01B 2203/0238; C01B 2203/1058; C01B 2203/1094; C01B 2203/1241

(57) ABSTRACT

A preparation method and an application method of a Ni—Co bimetallic catalyst for dry reforming of methane are provided, which relate to the field of catalytic material preparation technologies. The preparation method uses Ni and Co as active components of a catalyst for dry reforming of methane, alkaline earth metal salt as CO₂ adsorbent, and uses an immersion method to prepare a Ni—Co bimetallic catalyst with high performance. The prepared catalyst not only effectively overcomes a problem of poor stability of Ni-based catalysts, but also promotes the adsorption of CO₂ and improves the efficiency of dry reforming of methane. The preparation method of the Ni—Co bimetallic catalyst is simple and cost-effective, and exhibits excellent catalytic performance and stability in dry reforming reaction of methane.

### TECHNICAL FIELD

The disclosure relates to the field of catalytic material preparation technologies, and more particularly to a preparation method and an application method of a nickel-cobalt (Ni—Co) bimetallic catalyst for dry reforming of methane.

### BACKGROUND

Coal, oil and natural gas are main fossil fuels that people rely on for survival in the world today. The large-scale application of high carbon energy coal causes significant emissions of carbon dioxide (CO₂), depletion and drastic price fluctuations of the oil resources, as well as the inability of new energy sources (such as wind and solar energy) to replace fossil fuels on a large scale in the short term. Therefore, clean and environmentally friendly natural gas resources have attracted the attention of various countries. Overreliance on fossil fuels brings convenience to human life, but at the same time, it emits a large amount of CO₂. The continuous increase in CO₂ content in the atmosphere exacerbates the global greenhouse effect, and causes numerous environmental problems such as rising average temperatures of the Earth, slow rise of sea level, melting icebergs in the Arctic and Antarctic, and frequent extreme weather phenomena.

There is an urgent need for a significant strategy to reduce CO₂ emissions. In the industrial field, such as fossil fuel power plants and energy intensive industrial departments, which store captured or separated CO₂ in a geological reservoir. When the high cost of CO₂ purification and compression is considered, a more practical strategy to address the challenge of CO₂ is receiving increasing attention, which is to use CO₂ as a carbon raw material for value-added fuel and chemical production, rather than treating it as a pollutant, i.e., the capture and conversion of CO₂.

In the field of CO₂ conversion, dry reforming technology of methane has received widespread attention. However, low reforming efficiency and poor stability of catalyst are urgent problems to be solved in the field of dry reforming of methane. In various catalyst synthesis methods, a material preparation strategy that combines adsorbents and catalysts into one particle has become a promising process. This bifunctional catalyst utilizes the adsorbent to capture CO₂ generated during the reforming process in situ, while promoting the forward movement of the reforming reaction and water gas shift reaction, reducing a concentration of other by-products, and improving a conversion rate of the reaction raw materials. However, most of the currently prepared bifunctional catalysts usually do not have pore structures, have small specific surface areas, and stability of the currently prepared bifunctional catalysts significantly decreases after multiple cycles, which greatly affect the application of the bifunctional catalysts.

The bifunctional reforming catalysts can be divided into noble metal (such as rhodium abbreviated as Rh, ruthenium abbreviated as Ru, platinum abbreviated as Pt, and palladium abbreviated as Pd) based catalysts and non-noble metal (Ni and Co) based catalysts according to the different active metals. The noble metal based catalysts have high activity and good stability. However, due to the scarcity and high costs of the noble metal resources, the noble metal based catalysts are not suitable for large-scale industrial production. For the non-noble metal based catalysts, Ni-based catalysts have the optimal activity. However, there are some problems in the reaction process of the Ni-based catalysts, such as sintering of the active component Ni and formation of carbon deposit, which leads to the short life of the Ni-based catalysts. The sintering of the active component Ni will reduce the number of active centers in the catalysts, thereby reducing the reaction activity. The generated carbon deposits not only cover the active sites but also block the catalyst pores, thereby affecting the diffusion of reactants and products. The disclosure provides a preparation method of a Ni—Co bimetallic catalyst, which produces a porous structure catalyst with high specific surface area, and the porous structure catalyst successfully solves the problems of catalyst sintering and carbon deposition, and greatly improves the activity and stability of the catalyst.

### SUMMARY

In order to solve the above technical problems, the disclosure provides a Ni—Co bimetallic catalyst for dry reforming of methane, which has high conversion efficiency of the dry reforming of methane and stable catalytic performance.

On the one hand, the disclosure provides a preparation method of a Ni—Co bimetallic catalyst for dry reforming of methane, which has strong resistance to sintering and carbon deposition, and high activity and stability. The preparation method specifically includes the following steps (1)-(4).

In step (1), alkaline earth metal salt and tannin are mixed by ball milling to obtain a first mixture, and the first mixture is calcined to obtain a promoter MOₓ (MOₓ represents a metal oxide).

In step (2), nickel salt, cobalt salt, ethylene diamine tetraacetic acid (EDTA) and water are mixed to obtain a second mixture, aqueous ammonia is dripped into the second mixture to obtain a homogeneous solution, and a certain amount of the promoter MOₓ obtained in the step (1) is added into the homogeneous solution to obtain a mixed solution.

In step (3), ultrasonic dispersion is performed on the mixed solution obtained in the step (2) to obtain a dispersed solution, the dispersed solution is dried by rotary evaporation to obtain a precursor.

In step (4), the precursor obtained in step (3) and an anchoring agent melamine are ground evenly according to a certain ratio to obtain a ground mixture, the ground mixture is calcined under inert atmosphere to obtain the Ni—Co bimetallic catalyst for dry reforming of methane.

In an embodiment, a total mass fraction of Ni and Co in the Ni—Co bimetallic catalyst is in a range of 2% to 12%.

In an embodiment, in the step (1), a weight ratio of the alkaline earth metal salt to the tannin is 1:2.5-9, and the alkaline earth metal salt is calcium salt or magnesium salt.

In an embodiment, in the step (2), a weight ratio of the nickel salt:the cobalt salt, the EDTA:the water:the aqueous ammonia:the promoter MOₓ is 1:1-3:8-12:10-15:16-25:0.1-1.

In an embodiment, in the step (3), a period of the ultrasonic dispersion is 30 minutes (min), a temperature of the rotary evaporation is in a range of 50 Celsius degrees (° C.) to 90° C., and a period of the rotary evaporation is in a range of 0.5 hours (h) to 2 h.

In an embodiment, in the step (4), a weight ratio of the precursor to the anchoring agent melamine is 1:2-10.

In an embodiment, in the step (1), a rate of temperature change of the calcining is in a range of 1 Celsius degree per minute (° C./min) to 5° C./min, a temperature of the calcining is in a range of 400° C. to 800° C., and a period of the calcining is in a range of 3 h to 6 h.

In an embodiment, in the step (4), a rate of temperature change of the calcining is in range of 1° C./min to 5° C./min, a temperature of the calcining is in a range of 500° C. to 1000° C., and a period of the calcining is in a range of 1 h to 5 h.

In the other hand, the disclosure provides an application method of the Ni—Co bimetallic catalyst prepared by the preparation method, including: performing dry reforming of methane by using the Ni—Co bimetallic catalyst.

Compared to the related art, the Ni—Co bimetallic catalyst prepared in the disclosure has the following advantages.
(1) The disclosure has a wide range of raw material sources, a simple preparation process, easy and accurate control of the preparation conditions, and good repeatability of the obtained catalyst.
(2) In the disclosure, under the reaction conditions, a surface of MOₓ can adsorb CO₂ and generate a carbonic acid compound, which can decompose and release CO₂ at high temperatures, to help to promote the contact between the reaction gas and the catalyst, thereby enhancing conversion and reaction activity. In addition, since the doping of the alkaline earth metal salts plays a role in fixing Ni particles, which can avoid Ni sintering. On the other hand, the doping of the alkaline earth metal salts also suppresses the formation of carbon deposits, thereby improving the stability of the catalyst.
(3) The disclosure can change the composition of precursor salts in catalyst preparation to prepare coated catalysts with different active centers, which can be widely applied to other catalytic systems and have good universality.
(4) The catalyst prepared by the disclosure exhibits high efficiency and stable catalytic performance, has good environmental friendliness, and has good application prospects in the treatment of gases such as CO₂ and methane (CH₄).

### BRIEF DESCRIPTION OF DRAWINGS

FIG. 1 illustrates a transmission electron microscope (TEM) graph of a Ni—Co catalyst according to an embodiment of the disclosure.

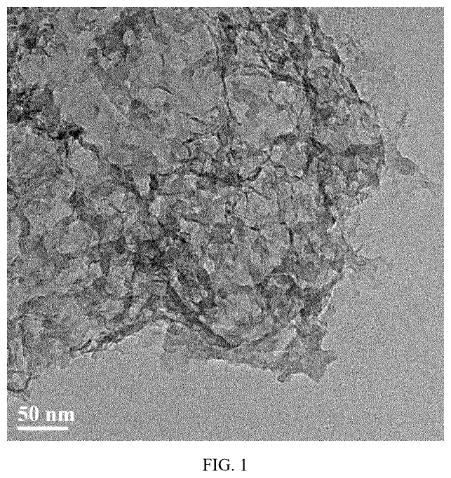

FIG. 2 illustrates an energy-dispersive X-ray spectroscopy (EDX) graph of the Ni—Co catalyst according to an embodiment of the disclosure.

FIG. 3 illustrates a schematic diagram of a stability test of the Ni—Co catalyst for dry reforming of methane.

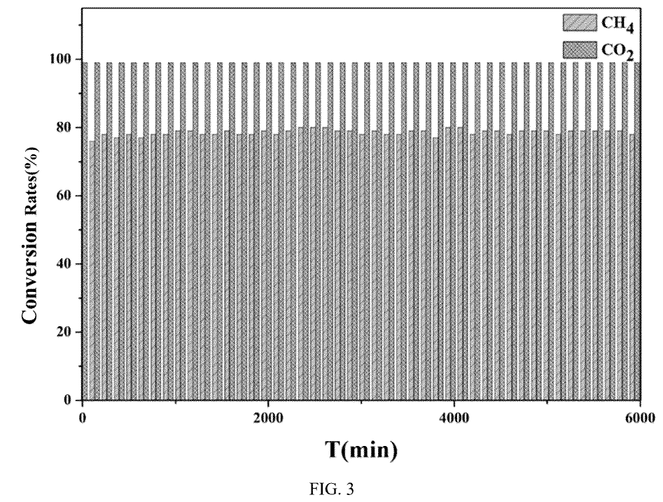

### DETAILED DESCRIPTION OF EMBODIMENTS

Technical solutions in embodiments of the disclosure will be clearly and completely described below. Apparently, the described embodiments are merely some of the embodiments of the disclosure, not all of them. The experimental methods in the following embodiments that do not specify specific conditions are usually operated under conventional conditions. Unless otherwise defined, all practical professional and scientific terms used in the disclosure have the same meanings as those skilled in the art.

### Embodiment 1

A Ni—Co bimetallic catalyst preparation method for dry reforming of methane is provided, and specifically includes the following steps (1)-(4).

In step (1), alkaline earth metal salt and tannin are mixed by ball milling to obtain a first mixture, and the first mixture is calcined to obtain a promoter MOₓ.

In step (2), nickel salt, cobalt salt, EDTA and water are mixed to obtain a second mixture, aqueous ammonia is dripped into the second mixture to obtain a homogeneous solution, and a certain amount of the promoter MOₓ obtained in the step (1) is added into the homogeneous solution to obtain a mixed solution.

In step (3), ultrasonic dispersion is performed on the mixed solution obtained in the step (2) to obtain a dispersed solution, the dispersed solution is dried by rotary evaporation to obtain a precursor.

In step (4), the precursor obtained in step (3) and an anchoring agent melamine are ground evenly according to a certain ratio to obtain a ground mixture, the ground mixture is calcined under inert atmosphere to obtain the Ni—Co bimetallic catalyst for dry reforming of methane. The Ni—Co bimetallic catalyst for dry reforming of methane is recorded as Ni—Co-MOₓ.

In the step (1), the alkaline earth metal salt is calcium acetate monohydrate.

In the step (1), a weight ratio of the alkaline earth metal salt to the tannin is 1:2.5.

In the step (2), the cobalt salt is cobalt nitrate hexahydrate (Co(NO₃)₂·6H₂O), and the nickel salt is nickel nitrate hexahydrate (Ni(NO₃)₂·6H₂O).

In the step (2), a weight ratio of the nickel salt:the cobalt salt, the EDTA:the water:the aqueous ammonia:MOₓ is 1:1:8:12:18:0.15.

In the step (3), a period of the ultrasonic dispersion is 30 min, a temperature of the rotary evaporation is 80° C., and a period of the rotary evaporation is 1 h.

In the step (4), a weight ratio of the precursor to the anchoring agent melamine is 1:5.

In the step (1), a rate of temperature change of the calcining is 5° C./min, a temperature of the calcining is 800° C., and a period of the calcining is 4 h.

In the step (4), a rate of temperature change of the calcining is 5° C./min, a temperature of the calcining is 800° C., and a period of the calcining is 2 h.

The prepared catalyst is recorded as Ni—Co-MOₓ, a mass fraction of Ni is 3%, and a mass fraction of Co is 3%.

### Embodiment 2

A Ni—Co bimetallic catalyst preparation method for dry reforming of methane is provided, and basically the same as the embodiment 1, the differences from the embodiment 1 are as follows.

In the step (1), the alkaline earth metal salt is magnesium carbonate pentahydrate.

In the step (1), the weight ratio of the alkaline earth metal salt to the tannin is 1:3.

In the step (2), the weight ratio of the nickel salt:the cobalt salt, the EDTA:the water:the aqueous ammonia:MOₓ is 1:3:8:15:16:1.

In the step (3), the temperature of the rotary evaporation is 50° C., and the period of the rotary evaporation is 2 h.

In the step (4), the weight ratio of the precursor to the anchoring agent melamine is 1:10.

In the step (1), the rate of temperature change of the calcining is 1° C./min, the temperature of the calcining is 400° C., and the period of the calcining is 3 h.

In the step (4), the rate of temperature change of the calcining is 1° C./min, the temperature of the calcining is 1000° C., and the period of the calcining is 5 h.

The prepared catalyst is recorded as Ni—Co-MOₓ, the mass fraction of Ni is 3%, and the mass fraction of Co is 9%.

### Embodiment 3

A Ni—Co bimetallic catalyst preparation method for dry reforming of methane is provided, and basically the same as the embodiment 1, the differences from the embodiment 1 are as follows.

In the step (1), the weight ratio of the alkaline earth metal salt to the tannin is 1:9.

In the step (2), the weight ratio of the nickel salt:the cobalt salt, the EDTA:the water:the aqueous ammonia:MOₓ is 1:2:12:10:25:0.1.

In the step (3), the temperature of the rotary evaporation is 90° C., and the period of the rotary evaporation is 0.5 h.

In the step (4), the weight ratio of the precursor to the anchoring agent melamine is 1:2.

In the step (1), the rate of temperature change of the calcining is 3° C./min, the temperature of the calcining is 800° C., and the period of the calcining is 6 h.

In the step (4), the rate of temperature change of the calcining is 4° C./min, the temperature of the calcining is 500° C., and the period of the calcining is 1 h.

The prepared catalyst is recorded as Ni—Co-MOₓ, the mass fraction of Ni is 3%, and the mass fraction of Co is 6%.

### Comparative Embodiment 1

A catalyst preparation method for dry reforming of methane is provided, which is basically the same as the embodiment 1, the differences from the embodiment 1 are as follows.

In the step (2), the cobalt nitrate hexahydrate is not added.

The prepared catalyst is recorded as Ni-MOₓ, the mass fraction of Ni is 3%.

### Comparative Embodiment 2

A catalyst preparation method for dry reforming of methane is provided, which is basically the same as the embodiment 1, the differences from the embodiment 1 are as follows.

In the step (2), the cobalt nitrate hexahydrate and the nickel nitrate hexahydrate are not added. The prepared catalyst is recorded as MOₓ.

### Comparative Embodiment 3

A Ni—Co catalyst preparation method for dry reforming of methane is provided, which is basically the same as the embodiment 1, the differences from the embodiment 1 are as follows.

In the step (2), the weight ratio of the nickel salt:the cobalt salt, the EDTA:the water:the aqueous ammonia:MOₓ is 1:1:8:12:18:0.75.

The prepared catalyst is recorded as Ni—Co-5MOₓ, the mass fraction of Ni is 3%, and the mass fraction of Co is 3%.

### Comparative Embodiment 4

A Ni—Co catalyst preparation method for dry reforming of methane is provided, which is basically the same as the embodiment 1, the differences from the embodiment 1 are as follows.

In the step (2), the weight ratio of the nickel salt:the cobalt salt, the EDTA:the water:the aqueous ammonia:MOₓ is 1:1:8:12:18:1.5.

The prepared catalyst is recorded as Ni—Co-10MOₓ, the mass fraction of Ni is 3%, and the mass fraction of Co is 3%.

### Comparative Embodiment 5

A Ni—Co catalyst preparation method for dry reforming of methane is provided, which is basically the same as the embodiment 1, the differences from the embodiment 1 are as follows.

In the step (2), the weight ratio of the nickel salt:the cobalt salt, the EDTA:the water:the aqueous ammonia:MOₓ is 1:1:4:12:18:0.75.

The prepared catalyst is recorded as Ni—Co-MOₓ-½EDTA, the mass fraction of Ni is 6%, and the mass fraction of Co is 6%.

### Comparative Embodiment 6

A Ni—Co catalyst preparation method for dry reforming of methane is provided, which is basically the same as the embodiment 1, the differences from the embodiment 1 are as follows.

In the step (2), the weight ratio of the nickel salt:the cobalt salt, the EDTA:the water:the aqueous ammonia:MOₓ is 1:1:2:12:18:0.75.

The prepared catalyst is recorded as Ni—Co-MOₓ-¼EDTA, the mass fraction of Ni is 12%, and the mass fraction of Co is 12%.

### Experiment Embodiment 1

Reaction performance of the catalyst samples prepared in the embodiments 1-3 and the comparative embodiments 1-7 are examined. The reactions are performed in a fixed bed reactor with continuous gas flow. 0.05 grams (g) of each catalyst is added into a quartz tube with small diameter ratio, the reaction conditions are as follows: 750° C., CO₂:CH₄:nitrogen (N₂)=1:1:8 (V:V:V), atmospheric pressure, and gas hour space velocity 14400 milliliters per gram per hour (mL·g⁻¹·h⁻¹). The products are analyzed by online gas chromatography, and the reaction results are listed in Table 1.

TABLE 1
Comparison of methane reforming activity

| | Conversion rate | | Conversion rate | |
|---|---|---|---|---|
| | of CH₄ (%) | | of CO₂ (%) | |
| Sample name | 12 h | 100 h | 12 h | 100 h |
| Ni—Co—MOₓ | 75.5 | 75.3 | 97.7 | 97.8 |
| Ni—Co—MOx-1 | 74.9 | 74.6 | 96.9 | 97.5 |
| Ni—Co—MOx-2 | 75.1 | 73.5 | 97.4 | 97.2 |
| Ni—MOₓ | 73.7 | 71.9 | 88.9 | 85.3 |
| MOₓ | 2.4 | 0 | 6.7 | 0 |
| Ni—Co—5MOₓ | 64.8 | 43.6 | 83.8 | 56.5 |
| Ni—Co—10MOₓ | 42.1 | 35.9 | 64.7 | 49.5 |
| Ni—Co—MOₓ-1/2EDTA | 35.7 | 26.3 | 68.4 | 43.5 |
| Ni—Co—MOₓ-1/4EDTA | 30.6 | 19.2 | 61.6 | 32.9 |

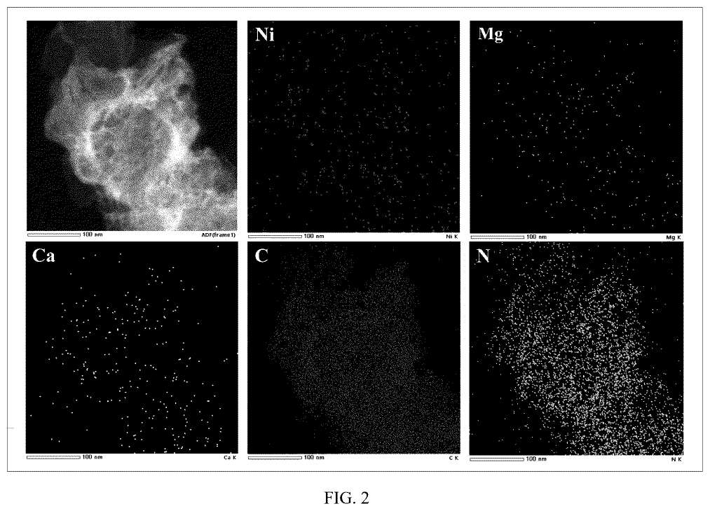

It can be seen from Table 1 that the Ni-based functional catalyst for dry reforming of methane prepared by the preparation methods provided by the embodiments 1-3 of the disclosure has high reaction activity during the reaction of dry reforming of methane to produce synthesis gas, which is much higher than that of the comparative embodiments 1-6. It can be seen from FIG. 2 that the catalyst has good activity and stability, does not lose activity after running for 100 h.

The above description is merely some of the embodiments of the disclosure. Any improvement or amendment of the technical solution of the disclosure without departing from principles of the disclosure should be regarded as the disclosed content of the disclosure and fall within a scope of protection of the disclosure.

What is claimed is:

1. A preparation method of a nickel-cobalt (Ni—Co) bimetallic catalyst for dry reforming of methane, comprising:
step (1), mixing alkaline earth metal salt and tannin by ball milling to obtain a first mixture, and calcining the first mixture to obtain a promoter MOₓ;
step (2), mixing nickel salt, cobalt salt, ethylene diamine tetraacetic acid (EDTA) and water to obtain a second mixture, dripping aqueous ammonia into the second mixture to obtain a homogeneous solution, and adding the promoter MOₓ obtained in the step (1) into the homogeneous solution to obtain a mixed solution;
step (3), performing ultrasonic dispersion on the mixed solution obtained in the step (2) to obtain a dispersed solution, and drying the dispersed solution by rotary evaporation to obtain a precursor;
step (4), grinding the precursor obtained in the step (3) and an anchoring agent melamine evenly to obtain a ground mixture, calcining the ground mixture under inert atmosphere to obtain the Ni—Co bimetallic catalyst for dry reforming of methane.

2. The preparation method of the Ni—Co bimetallic catalyst for dry reforming of methane as claimed in claim 1, wherein in the step (2), a weight ratio of the nickel salt:the cobalt salt, the EDTA:the water:the aqueous ammonia:the promoter MOₓ is 1:1-3:8-12:10-15:16-25:0.1-1.

3. The preparation method of the Ni—Co bimetallic catalyst for dry reforming of methane as claimed in claim 1, wherein in the step (1), a weight ratio of the alkaline earth metal salt to the tannin is 1:2.5-9.

4. The preparation method of the Ni—Co bimetallic catalyst for dry reforming of methane as claimed in claim 1, wherein in the step (4), a weight ratio of the precursor to the anchoring agent melamine is 1:2-10.

5. The preparation method of the Ni—Co bimetallic catalyst for dry reforming of methane as claimed in claim 1, wherein a total mass fraction of Ni and Co in the Ni—Co bimetallic catalyst is in a range of 2% to 12%.

6. The preparation method of the Ni—Co bimetallic catalyst for dry reforming of methane as claimed in claim 1, wherein the alkaline earth metal salt is calcium salt or magnesium salt.

7. The preparation method of the Ni—Co bimetallic catalyst for dry reforming of methane as claimed in claim 1, wherein in the step (3), a temperature of the rotary evaporation is in a range of 50° C. to 90° C., and a period of the rotary evaporation is in a range of 0.5 h to 2 h.

8. The preparation method of the Ni—Co bimetallic catalyst for dry reforming of methane as claimed in claim 1, wherein in the step (1), a rate of temperature change of the calcining is in a range of 1° C./min to 5° C./min, a temperature of the calcining is in a range of 400° C. to 800° C., and a period of the calcining is in a range of 3 h to 6 h; and in the step (4), a rate of temperature change of the calcining is in range of 1° C./min to 5° C./min, a temperature of the calcining is in a range of 500° C. to 1000° C., and a period of the calcining is in a range of 1 h to 5 h.

9. The Ni—Co bimetallic catalyst for dry reforming of methane, wherein the Ni—Co bimetallic catalyst is prepared by the preparation method of the Ni—Co bimetallic catalyst for dry reforming of methane as claimed in claim 1.

10. An application method of the Ni—Co bimetallic catalyst for dry reforming of methane as claimed in claim 9, comprising: performing dry reforming of methane by using the Ni—Co bimetallic catalyst.
